(19) United States
(12) Patent Application Publication
(10) Pub. No.: US 2007/0094359 A1
(43) Pub. Date: Apr. 26, 2007

(54) Method and apparatus for configuring a client computer using a global configuration profile

(76) Inventor: Douglas Robert Lamoureux, Rocklin, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/256,327

(22) Filed: Oct. 20, 2005

(51) Int. Cl. G06F 15/177

(52) U.S. Cl. 709/220

(57) ABSTRACT

A method and apparatus for configuring a client computer by retrieving a global configuration profile; parsing the global configuration profile; identifying a variable tag within the configuration profile; evaluating the variable tag; and setting a configuration attribute according to the evaluated tag.

### BACKGROUND

Computer systems, for example a personal workstation, are typically configured using a configuration file that is stored locally on the computer. The configuration file provides various directives to an operating system, which ultimately controls the operation of the computer system. It should be appreciated that the configuration file is retrieved by the operating system during system started. The operating system parses the configuration file in order to extract specific directives contained therein. The operating system then performs configuration activities according to the extracted directives.

It should be appreciated that each individual computer system stores a local configuration file which dictates a specific configuration for the individual machine. As such, a system administrator bears the task of “setting up” the configuration file for a particular machine based on specific requirements commensurate with the application of that machine. This can become a very daunting task, especially in situations where many individual computer systems are utilized within a particular organization.

For example, in a large entity, hundreds, if not thousands of individual workstations are typically deployed throughout the enterprise. Each of these individual workstations must individually be configured for a particular user or application within the enterprise. All of a sudden, the job of system administrator is far from a coveted position. In fact, several individual system administrators can all be consumed merely by the task of establishing configuration files for each machine in the enterprise.

### BRIEF DESCRIPTION OF THE DRAWINGS

Several alternative embodiments will hereinafter be described in conjunction with the appended drawings and figures, wherein like numerals denote like elements, and in which:

FIG. 1 is a pictorial illustration that depicts one example use case for a method for configuring a client computer using a global configuration profile;

FIG. 2 is a flow diagram that depicts one example method for configuring a client computer;

FIGS. 3 and 4 are individual flow diagrams that illustrate alternative methods for retrieving a global configuration profile;

FIG. 5 is a flow diagram that depicts alternative example methods for identifying a variable tag;

FIG. 6 is a flow diagram that depicts one example method for evaluating a variable tag;

FIG. 7 is a block diagram that depicts one example embodiment of a computer system that is capable of configuring itself in accordance with a global configuration profile; and

FIG. 8 is a data flow diagram that depicts the internal operation of various alternative example embodiments of a computer system capable of configuring itself according to a global configuration profile.

### DETAILED DESCRIPTION

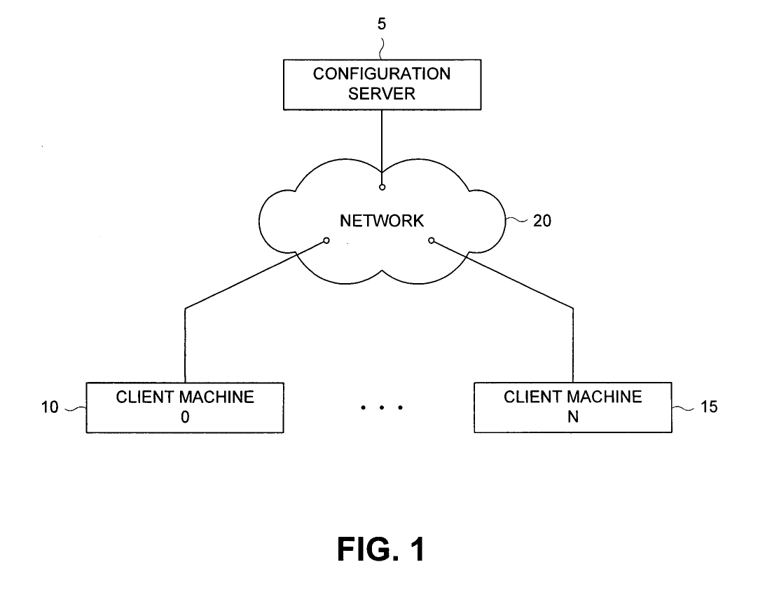

FIG. 1 is a pictorial illustration that depicts one example use case for a method for configuring a client computer using a global configuration profile. It should be appreciated that, according to one illustrative use case, a method for configuring a client computer is utilized in an environment wherein a plurality of client machines (10, 15) are communicatively associated with each other by means of a network 20. Such client machines, according to one illustrative use case, comprise personal computer workstations. It should be appreciated, however, that the present method can be utilized in various environments and claims appended hereto are not intended to be constrained to any particular application. According to this illustrative use case, a configuration server 5 is also communicatively associated with each of the client machines (10, 15) by means of the network 20. In this illustrative use case, a particular client machine (e.g. client machine 10), obtains a global configuration profile from the configuration server 5 upon system startup. Accordingly, the client machine 10 uses the global configuration profile to establish a local configuration within the client machine 10.

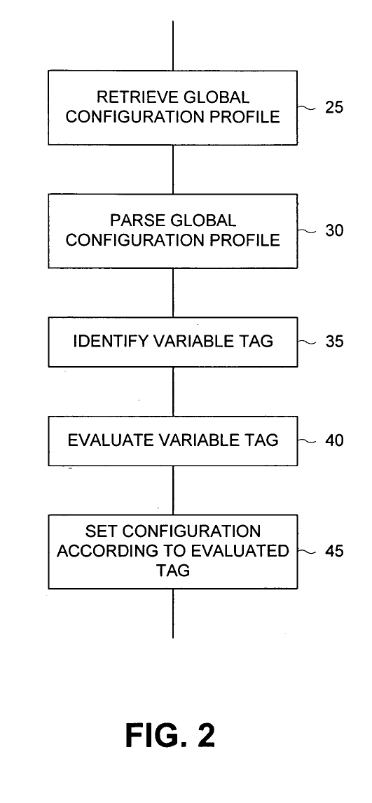

FIG. 2 is a flow diagram that depicts one example method for configuring a client computer. According to this example method, a client computer is configured by retrieving a global configuration profile (step 25). It should be appreciated that, according to various example methods, the global configuration profile is retrieved from a remote data repository, e.g. a configuration server 5. The global configuration profile is then parsed (step 30). Parsing of the global configuration profile enables the identification of variable tags (step 35) that are included in the global configuration profile. Once a variable tag is identified, the variable tag is evaluated (step 40). The client computer then sets an internal configuration according to the evaluated tag (step 45).

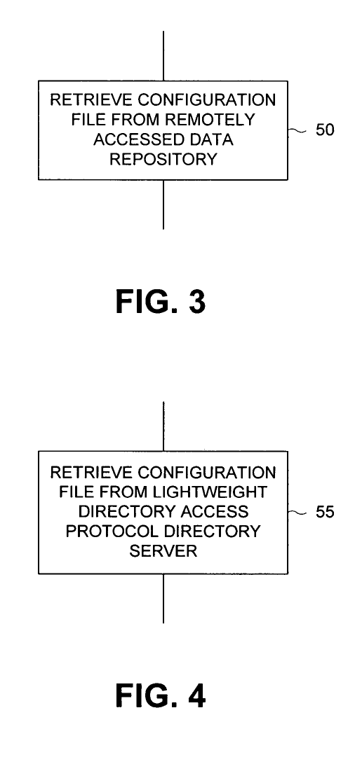

FIGS. 3 and 4 are individual flow diagrams that illustrate alternative methods for retrieving a global configuration profile. As already discussed, one variation of the present method provides for retrieving a configuration profile from a remotely accessed data repository (step 50). In this situation, a global configuration file is retrieved from the remotely accessed data repository. In yet another variation of the present method, a global configuration file is retrieved from a lightweight directory access protocol (LDAP) directory server (step 55) as a means for obtaining a global configuration profile.

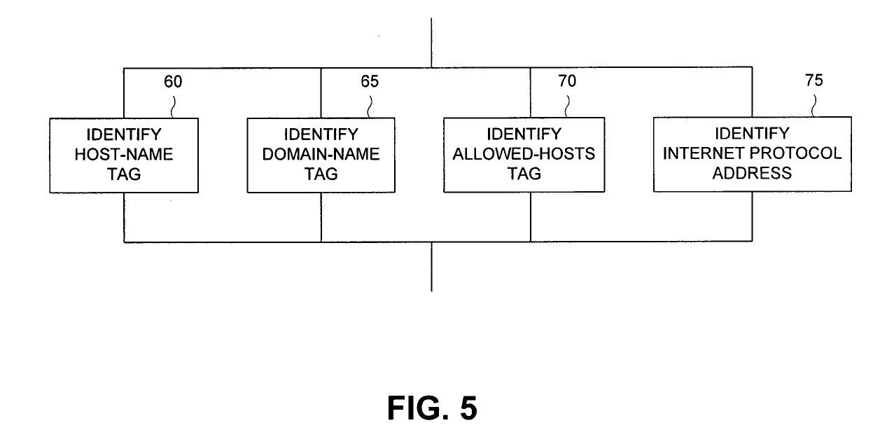

FIG. 5 is a flow diagram that depicts alternative example methods for identifying a variable tag. It should be appreciated that a global configuration profile includes one or more variable tags organized in a manner facilitating the establishment of a local configuration in a client computer. One example of a variable tag includes a host-name. As such, one variation of the present method provides for identifying a host-name tag (step 60) included in a global configuration profile. Typically, the host-name tag is used to enable a client machine to adopt a particular host name. According to yet another variation of the present method, a domain-name tag is identified (step 65) in a global configuration profile. In this situation, the domain-name tag is used to enable a client machine to associate itself with a particular domain name. In yet another variation of the present method, an allowed-hosts tag is identified (step 70) in a global configuration profile. In this situation, a client machine establishes an enumeration of remote machines which it will allow to access it's own internal resources. As such, the enumeration of allowed remote machines is established according to an identified allowed hosts tag. In yet another variation of the present method, an Internet protocol address tag is identified (step 75) in a global configuration profile. The Internet protocol address tag enables the client machine to set its own Internet protocol address, which it then uses when accessing particular network resources.

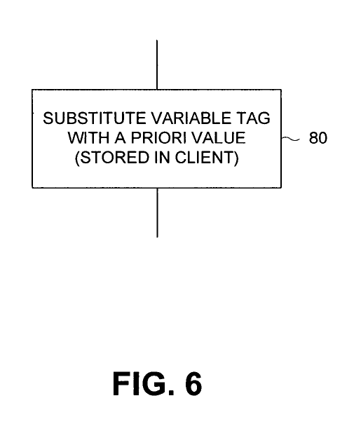

FIG. 6 is a flow diagram that depicts one example method for evaluating a variable tag. According to this example method, a variable tag is evaluated by substituting the variable tag with an a priori value (step 80), which is typically stored in the client machine. For example, when the client machine begins to evaluate a particular variable tag, the client machine will obtain a value for a particular tag from a local file. In yet another example variation of the present method, the client machine will obtain a value from a hardware resource included in the client machine. For example, a volume identifier on a hard drive is used in one example method for establishing a name for an individual client computer. Although FIG. 6 illustrates evaluation of a variable tag in accordance with an a priori value, other example methods provide for evaluating a variable tag based on an equation included in a global configuration profile. It should be appreciated that the equation included in such a global configuration profile typically requires a priori values stored in the client machine itself. However, the claims appended hereto are not to be constrained to such variations of the present method.

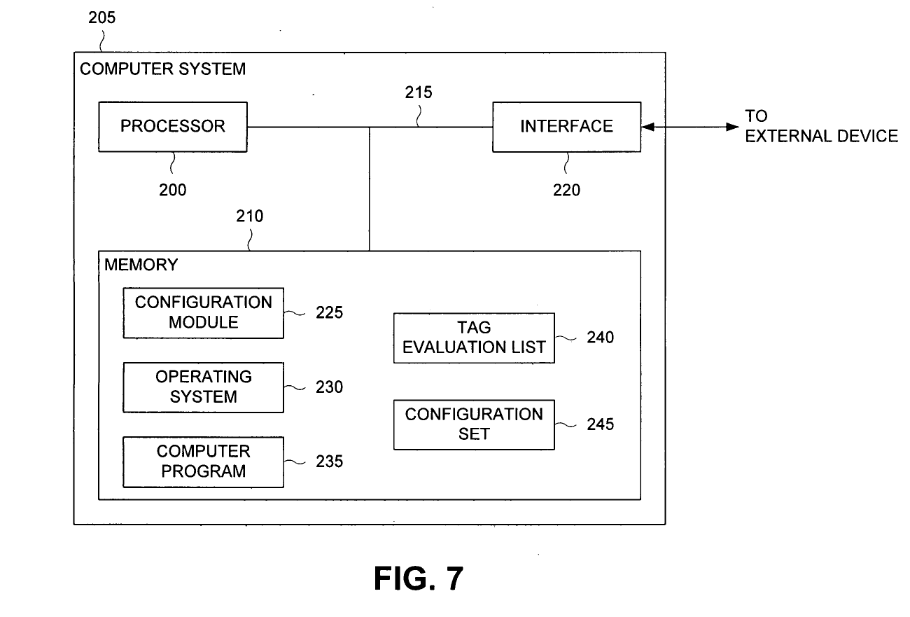

FIG. 7 is a block diagram that depicts one example embodiment of a computer system that is capable of configuring itself in accordance with a global configuration profile. According to this example embodiment, such a computer system comprises one or more processors 200, an interface 220 for enabling the processor to communicate with an external device and a memory 210. It should be appreciated that the memory 210 is used to store one or more instruction sequences and is also used for storing an operating configuration.

Also included in various example alternative embodiments of the system are one or more functional modules. A functional module is typically embodied as an instruction sequence. An instruction sequence that implements a functional module, according to one alternative embodiment, is stored in the memory 210. The reader is advised that the term “minimally causes the processor” and variants thereof is intended to serve as an open-ended enumeration of functions performed by the processor 200 as it executes a particular functional module (i.e. instruction sequence). As such, an embodiment where a particular functional module causes the processor 200 to perform functions in addition to those defined in the appended claims is to be included in the scope of the claims appended hereto.

The functional modules (i.e. their corresponding instruction sequences) described herein that enable configuration of a client computer according to the present method are, according to one alternative embodiment, imparted onto computer readable medium. Examples of such medium include, but are not limited to, random access memory, read-only memory (ROM), compact disk ROM (CD ROM), floppy disks, hard disk drives, magnetic tape and digital versatile disks (DVD). Such computer readable medium, which alone or in combination can constitute a stand-alone product, can be used to convert a general-purpose computing platform into a client computer that is capable of configuring itself according to the techniques and teachings presented herein. Accordingly, the claims appended hereto are to include such computer readable medium imparted with such instruction sequences that enable execution of the present method and all of the teachings herein described.

According to one example embodiment, the computer system 205 claimed herein includes one or more instruction sequences stored in the memory including a configuration module 225 and an operating system 230. In yet another alternative example embodiment, a user computer program 235 is also stored in the memory. It should be appreciated that, according to one alternative example embodiment, the memory 210 is also used to store a tag evaluation list 240. In yet another alternative example embodiment, the memory 210 is used to store a configuration set 245. The configuration set 245 is used by the operating system 230 as a basis for an operating configuration. The configuration set 245 is typically set by the processor 200 as it executes the configuration module 225.

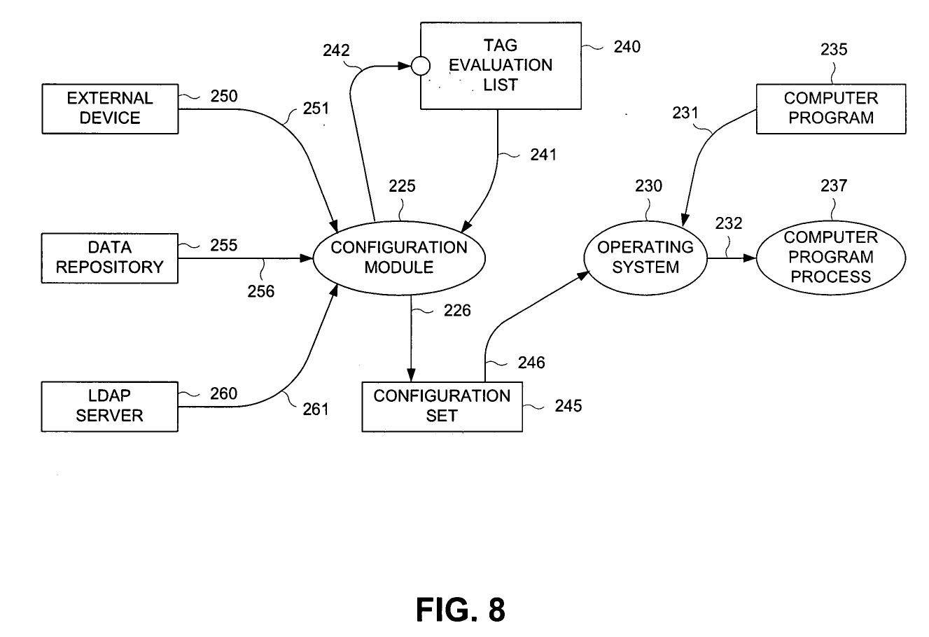

FIG. 8 is a data flow diagram that depicts the internal operation of various alternative example embodiments of a computer system capable of configuring itself according to a global configuration profile. According to one example embodiment, the processor 200, upon system start, executes the configuration module 225. The configuration module 225, when executed by the processor 200, minimally causes the processor to retrieve 251 a global configuration profile from an external device 250. It should be appreciated that, according to one alternative example embodiment, the configuration module 225 causes the processor to retrieve a global configuration profile by minimally causing the processor 200 to retrieve 256 a global configuration file from a remotely accessed data repository 255. In yet another alternative example embodiment, the configuration module 225 causes the processor to retrieve a global configuration profile by minimally causing the processor 200 to retrieve 261 a global configuration file from a lightweight directory access protocol (LDAP) server 260. The configuration module 225 further minimally causes the processor 200 to establish an operating configuration in the memory 210. In one alternative example embodiment, the configuration module 225 causes the processor to establish an operating configuration by structuring a configuration set 245 that is stored in the memory 210. As the client computer continues to operate, the processor 200 begins operating system 230 execution. It should be appreciated that, according to one alternative example embodiment, the configuration module 225 is included within the operating system 230. In this description, the configuration module 225 is shown as an external functional module relative to the operate system 230 for the purposes of clarity. Accordingly, the claims appended hereto are not intended to be limited in scope to such a configuration and any configuration wherein the configuration module 225 is included in the operating system 230 is intended to be covered by the scope of the claims appended hereto. The operating system 230 retrieves 231 a computer program 235 in order to instantiate 232 a computer program process 237. The operating system 230 controls its own operation and the operation of an instantiated computer program process 237 in accordance with the configuration set 245 that it retrieves 246 from the memory 210.

According to yet another alternative example embodiment, the configuration module 225, when executed by the processor 200, minimally causes the processor to identify in a retrieved global configuration profile at least one of a host-name tag, a domain-name tag, allowed-hosts tag and an Internet protocol address. Other variable tags are identified by the processor 200 as it executes alternative example embodiments of the configuration module 225. In one alternative example embodiment, the configuration module 225 causes the processor to evaluate a variable tag by retrieving 241 an a priori value from the tag evaluation list 240. It should be appreciated that the tag evaluation list 240, according to this alternative example embodiment, is indexed 242 according to a particular variable tag.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents.

What is claimed is:

1. A method for configuring a client computer comprising:
retrieving a global configuration profile;
parsing the global configuration profile;
identifying a variable tag within the configuration profile;
evaluating the variable tag; and
setting a configuration attribute according to the evaluated tag.

2. The method of claim 1 wherein retrieving a global configuration profile comprises retrieving a global configuration file from a remotely accessed data repository.

3. The method of claim 1 wherein retrieving a global configuration profile comprises retrieving a global configuration file from a light weight directory access protocol directory server.

4. The method of claim 1 wherein identifying a variable tag includes identifying at least one of a host-name tag, domain-name tag, an allowed-hosts tag, and an internet protocol address.

5. The method of claim 1 wherein evaluating the variable tag comprises substituting the variable tag with an a priori value stored in the client computer.

6. A client computer comprising:
one or more processors for executing an instruction sequence;
interface for enabling the processor to communicate with an external device;
memory for storing one or more instruction sequences and also for storing an operating configuration; and
one or more instruction sequences stored in the memory including:
configuration module that, when executed by the processor, minimally causes the processor to retrieve a global configuration profile from an external device using the interface and further minimally causes the processor to establish an operating configuration in the memory according to the retrieved global configuration profile; and
operating system that, when executed by the processor, minimally causes the processor to control the client computer according to the operating configuration stored in the memory.

7. The client computer of claim 6 wherein the configuration module causes the processor to retrieve a global configuration profile by minimally causing the processor to retrieve a file from a remotely accessed data repository.

8. The client computer of claim 6 wherein the configuration module causes the processor to retrieve a global configuration profile by minimally causing the processor to retrieve a file from a light weight directory access protocol server.

9. The client computer of claim 6 wherein the configuration module causes the processor to establish a configuration in the memory by minimally causing the processor to identify in the retrieved global configuration profile at least one of a host-name tag, domain-name tag, an allowed-hosts tag, and an internet protocol address.

10. The client computer of claim 6 further comprising an a priori tag evaluation list stored in the memory and wherein the configuration module causes the processor to establish a configuration in the memory by minimally causing the processor to substitute a variable tag included in a retrieved global configuration profile with a value stored in the a priori tag evaluation list.

11. A computer readable medium having imparted there on one or more instruction sequences including:
configuration module that, when executed by a processor, minimally causes a processor to retrieve a global configuration profile from an external device using the interface and further minimally causes the processor to establish an operating configuration in a memory according to the retrieved global configuration profile.

12. The computer readable medium of claim 11 wherein the configuration module causes a processor to retrieve a global configuration profile by minimally causing a processor to retrieve a file from a remotely accessed data repository.

13. The computer readable medium of claim 11 wherein the configuration module causes a processor to retrieve a global configuration profile by minimally causing a processor to retrieve a file from a light weight directory access protocol server.

14. The computer readable medium of claim 11 wherein the configuration module causes a processor to establish a configuration in a memory by minimally causing a processor to identify in the retrieved global configuration profile at least one of a host-name tag, domain-name tag, an allowed-hosts tag, and an internet protocol address.

15. The computer readable medium of claim 11 wherein the configuration module causes the processor to establish a configuration in a memory by minimally causing the processor to substitute a variable tag included in a retrieved global configuration profile with a value stored in an a priori tag evaluation list that is also stored in the memory.

16. A client computer comprising:
means for retrieving a global configuration profile;
means for establishing an operating configuration according to the global configuration profile; and
means for executing a computer program in accordance with the established operating configuration.

17. The client computer of claim 16 wherein the means for retrieving a global configuration profile comprises a means for retrieving a file from a remotely accessed data repository.

18. The client computer of claim 16 wherein the means for retrieving a global configuration profile comprises a means for retrieving a file from a light weight directory access protocol server.

19. The client computer of claim 16 wherein the means for establishing an operating configuration comprises a means for establishing an operating configuration according to at least one of a host-name tag, domain-name tag, an allowed-hosts tag, and an internet protocol address that is included in a retrieved global configuration profile.

20. The client computer of claim 16 wherein the means for establishing an operating configuration comprises a means for substituting a value for a variable tag included in a retrieved global configuration profile, wherein the substituted value is stored in the client computer.
